(19) United States
(12) Patent Application Publication
(10) Pub. No.: US 2017/0191406 A1
(43) Pub. Date: Jul. 6, 2017

(54) HIGH-PRESSURE SPARK-IGNITION AND STRATIFICATION DEVICE FOR AN INTERNAL COMBUSTION ENGINE

(71) Applicant: Vianney RABHI, Lyon (FR)

(72) Inventor: Vianney RABHI, Lyon (FR)

(21) Appl. No.: 15/466,758

(22) Filed: Mar. 22, 2017

Related U.S. Application Data
(62) Division of application No. 13/760,338, filed on Feb. 6, 2013.
(60) Provisional application No. 61/595,275, filed on Feb. 6, 2012.

(51) Int. Cl. F02B 17/00; F02B 29/04; F02M 51/06; F01N 3/10; F02P 13/00; F02M 31/10; F02M 21/02; F02M 26/22; F02M 26/70; F02M 26/68; F02M 31/04; F02M 31/13; F02B 21/00

(52) U.S. Cl. CPC F02B 17/005; F02M 31/13; F02B 29/0437; F02M 51/061; F02M 51/0603; F01N 3/10; F02P 13/00; F02B 21/00; F02M 21/0215; F02M 26/22; F02M 26/70; F02M 26/68; F02M 31/042; F02M 31/10

(57) ABSTRACT

A high-pressure spark-ignition and stratification device (2) for internal combustion engine (1) includes:
a stratification valve (20) closing a stratification conduit (23) which opens into a stratification prechamber (79), the conduit also opening into a stratification chamber (24) connected by a stratification injection conduit (39) to the combustion chamber (9) of the internal combustion engine (1), the conduit opening near protruding electrodes (26) of a spark plug (25), the electrodes being positioned in the combustion chamber;
a stratification actuator (27) responsible for lifting the stratification valve (20);
a stratification line (28) connecting the stratification prechamber (79) to the outlet of a stratification compressor (29);
a stratification fuel injector (33);
elements for recirculating previously cooled exhaust gases (40).

### FIELD OF THE INVENTION

The present invention relates to a high-pressure spark-ignition and stratification device for a reciprocating internal combustion engine with a highly diluted charge using means for recirculating previously cooled exhaust gases, known as “external cooled EGR” means.

### BACKGROUND OF THE INVENTION

The thermodynamic efficiency of reciprocating internal combustion heat engines depends on a number of factors including, firstly, the duration and phasing of the combustion intended to raise the temperature of the gases trapped in the combustion chamber after they have been compressed; secondly, the heat losses of said gases in contact with the internal walls of said engine; and, thirdly, the rate of expansion of said gases, said expansion allowing said gases to exert a thrust on the piston of said engine so as to convert the heat energy released by said combustion into mechanical work.

However, the positive work produced by the thrust of said gases on said piston in their expansion is partially lost before it can be used at the output shaft of the heat engine. This is due to the negative, or resistive, work created by the pumping and transfer of said gases in the various intake and exhaust conduits and circuits of the heat engine, by the mechanical friction between the parts of said engine, and by the driving of the accessories and auxiliary equipment of said engine.

Thus, for a given quantity of fuel consumed, the efficiency of a reciprocating internal combustion heat engine rises with an increase in the positive work done on the piston of said engine by the gas compression-expansion cycle, and with a simultaneous decrease in the negative, or resistive, work produced by the entry and exit of said gases into and from said engine and the work produced by the mechanism of said engine and its accessories.

In order to convert the heat released by combustion into mechanical work as efficiently as possible, it is preferable for the fuel-air mixture introduced into the cylinder of the heat engine to burn rapidly, near the top dead center of the piston of said engine, in other words at quasi-constant volume. This remains true as long as the gas temperature does not reach such a high level that the heat exchange between said gases and the internal walls of the combustion chamber of the engine becomes excessive. It also remains true as long as the pressure gradient created by the combustion does not result in excessive noise and is not caused by pinging.

Pinging is a spontaneous gas combustion which occurs after a certain period, under the combined effect of pressure and temperature, and which produces very large pressure waves which also tend to increase the heat exchange between said gases and said walls, notably by detaching the layer of insulating air covering the surface of said walls. Thus pinging is an undesirable phenomenon, which reduces the efficiency of the heat engine and which also tends to damage the internal members of the engine by thermal and mechanical overload.

Among the main methods of initiating combustion in the combustion chamber of reciprocating internal combustion heat engines, it is possible to distinguish between spark ignition, spontaneous ignition of the fuel on the injection front which is characteristic of diesel engines, and compression ignition using methods known by the abbreviations CAI (for Controlled Auto Ignition) or HCCI (for Homogeneous Charge Compression Ignition).

The combustion rate of controlled ignition engines depends primarily on the air/fuel ratio and the content of residual burnt gases in the fuel-air mixture introduced into the combustion chamber of said engines, on the distance that must be covered by the flame in order to burn all said mixture, and on the microturbulence within said mixture, the flame propagation speed being approximately proportional to said turbulence.

In the diesel cycle, the combustion rate is mainly determined by the diesel fuel injection quality, and by the ketane number of said diesel fuel. In CAI or HCCI, the compression ratio, the initial temperature of the fuel-air mixture and its content of burnt gases, the characteristics of the fuel used and the homogeneity of the charge are factors which determine the initiation and rate of combustion. Regardless of the methods of initiating combustion, the rate of said combustion determines the rate of energy release, usually expressed in degrees of rotation of the crankshaft between the start and end of combustion, following a curve showing the cumulative fraction of burnt fuel as a function of the angular position of the crankshaft, one degree at a time.

Regardless of the combustion mode of the reciprocating internal combustion heat engines, in practice their efficiency is always higher when the heat exchange between the hot gases and the internal walls of said engines is minimal.

It should be noted that said heat exchange decreases if there is a small temperature difference between said gases and said walls, if there is little or no turbulent convection increasing the power of said exchange above that which is due to simple thermal conduction and radiation, and if the mass per unit volume of said gases is low.

In order to reduce the temperature difference between the hot gases and the internal walls of a reciprocating internal combustion heat engine, the temperature of said walls can be raised, and/or the temperature of said gases can be lowered. However, these two arrangements rapidly reach their limits in the improvement of the efficiency of controlled ignition reciprocating internal combustion heat engines.

This is because increasing the temperature of the internal walls of the combustion chamber of a reciprocating internal combustion heat engine has the disadvantage of reducing its filling capacity: the cold air or gas mixture coming into contact with said hot walls expands instantaneously, thereby reducing the volumetric efficiency of said engine in the intake phase, and consequently reducing its overall efficiency. Furthermore, the cold air or gas mixture overheated in this way makes the engine more liable to pinging, which must be compensated for, by providing a lower compression/expansion ratio and/or by providing delayed ignition, although both of these arrangements also reduce the efficiency of said engine. Various tests have been conducted in order to raise the temperature of the internal walls of the combustion chamber, as in the case of the so-called “adiabatic” engine with a ceramic combustion chamber and cylinders, made by Toyota. This engine offers very limited advantages in terms of efficiency, notably because, in the final analysis, the excessively high wall temperature tends to increase the heat loss of the gases on said walls, by comparison with other engines in which the cooler walls are more favorable to the maintenance and efficacy of the fine layer of insulating air which covers the internal walls of all reciprocating internal combustion heat engines. For these reasons, “adiabatic” engines have not progressed beyond the experimental stage.

As an alternative to raising the temperature of the internal walls of the combustion chamber, it is possible to reduce the temperature of the gases by diluting them either with added air or with exhaust gases which may or may not be previously cooled, these exhaust gases being obtained from the preceding cycle or cycles. By diluting the fuel-air charge introduced into the combustion chamber of a reciprocating internal combustion heat engine with a gas which does not participate in the combustion, it is possible to increase the total heat capacity of said charge in order to reduce its mean temperature for a given amount of energy released by said combustion.

Furthermore, regardless of the diluting gas used, it contributes to the conversion of the heat released by combustion into mechanical work. However, in the case of controlled spark ignition engines, the propagation of the flame in a mixture which is excessively lean in fuel or lean in oxygen is either too slow or is impossible. This results in reduced thermodynamic efficiency, because the combustion takes place to an excessive degree at non-constant volume, as well as highly unstable combustion and ignition failures.

In order to dilute the charge introduced into the cylinder of a controlled ignition reciprocating internal combustion heat engine without suffering excessively from the last-mentioned drawbacks, there is an alternative approach in which said charge is stratified; in other words, a pocket of combustible fuel-air mixture centered around the ignition point of said engine is created, said pocket being surrounded with a mixture lean in fuel, highly diluted with cold air and/or exhaust gases in such proportions that said lean mixture is still mostly combustible.

Said pocket is formed, notably, by the movements of the gases within the combustion chamber of said engine, said movements being caused, notably, by the geometry of the intake conduits of said engine and of the walls of said chamber, as well as by the dynamics and shape of the fuel jet injected directly into said chamber.

This method, known as the “stratified charge” method, usually requires the use of direct fuel injection and results in a charge which is rich in fuel around the ignition point, lean in fuel in the remaining area, and rich in oxygen throughout, giving rise to various problems in modern engines, notably in view of the regulations on pollution emissions.

This is because said charge stratified in this way must contain sufficient oxygen to ensure good initiation of combustion in the part of the charge around the ignition point, and sufficient oxygen in its remaining part to ensure good development of said combustion and its propagation throughout the volume of the combustion chamber of the engine, including the areas lean in fuel.

The excess oxygen which is characteristic of the operation of stratified charge engines according to the prior art makes it impossible to decrease nitrogen oxides by the three-way catalysis which is normally used for post-treatment of exhaust gases from controlled ignition engines.

In order to compensate for this problem which affects both stratified charge engines and engines with a lean mixture operating with excess oxygen, systems of post-treatment of nitrogen oxides in an oxidizing medium must be used, such as NOx traps or SCR (selective catalytic reduction), but said systems are particularly costly and sensitive to the quality and sulfur content of fuels, as well as being heavy and bulky.

It should be noted that the problems associated with stratified charges include the delayed direct injection of the fuel required for forming a fuel-rich pocket centered around the ignition point, said delayed injection resulting in a considerable production of fine particles which are health hazards.

Another problem associated with the stratified charge method is its operating range which is too limited at low loads, thus limiting its efficacy in reducing fuel consumption in currently used motor vehicles, particularly those having engines with a small cylinder capacity relative to their weight.

The latter problem which is related to the post-treatment of nitrogen oxides in an oxidizing medium can be avoided by providing compression ignition of the charge, as proposed in the CAI and HCCI methods, instead of spark ignition. These ignition methods lead to low-temperature combustion which produces practically no nitrogen oxides, and therefore enables the charge to be highly diluted with excess oxygen and/or the burnt gases initially produced in the preceding cycle or cycles, without the need to post-treat said oxides. Since it is not initiated by a spark, CAI or HCCI combustion avoids the constraints imposed by flame propagation from a single ignition point, as the combustion is initiated spontaneously at many points. However, CAI and HCCI are particularly sensitive to any variation in one or more of the parameters which enable it to operate, including, for example, the initial temperature of the charge, the effective compression ratio to which it is subjected, the quality of fuel contained in it, and its content of burnt gases. CAI or HCCI combustion also generates a high pressure gradient, because it is extremely fast, and therefore produces disagreeable acoustic emissions.

Furthermore, like the stratified charge method, CAI and HCCI only operate at relatively low loads, thus limiting its efficacy in reducing fuel consumption in currently used motor vehicles, particularly those having engines with a small cylinder capacity relative to their weight.

An alternative to the use of a stratified charge or a homogeneous lean mixture with excess oxygen would be to replace the excess oxygen introduced into the charge with the recirculated burnt gases from the preceding cycle or cycles, using the method known to those skilled in the art as EGR (standing for exhaust gas recirculation). The problem with EGR is that, if cooling is not used (internal EGR), it increases the sensitivity of the heat engine to pinging, which adversely affects the efficiency of the engine, while if said EGR is previously cooled in a heat exchanger (external cooled EGR) the initiation and propagation of the flame become random and unstable. In all cases, it is difficult to combine EGR with stratification, where the lean areas would become incombustible.

As mentioned above, it is preferable for the fuel-air mixture introduced into the cylinder of any reciprocating internal combustion heat engine to burn rapidly, near the top dead center of the piston of said engine, in other words at quasi-constant volume, and with the lowest possible heat loss at the walls.

In the case of controlled ignition engines, fast burning of said charge conflicts with the aim of diluting the charge with a gas which does not participate in its combustion, in order to reduce the heat losses on the internal walls of said engines, because a gas of this type tends to reduce the propagation speed of the flame in the volume containing said charge.

In order to restore a higher flame propagation speed, the internal turbulence of the fuel-air mixture can be increased, but said turbulence must not excessively increase the convective exchange, which magnifies the heat loss at the walls, thus counteracting the desired effect of charge dilution.

Another method of restoring said propagation speed may be to increase the compression ratio of the internal combustion heat engine with the aim of increasing the density and enthalpy of the charge, both of which factors are favorable to said propagation speed.

However, this method is difficult to use in engines with a fixed compression ratio, in which providing a markedly high compression ratio would limit the torque at low engine speed, thus increasing the mean fuel consumption of the motor vehicles.

In this context, internal combustion heat engines with a variable compression ratio have the decisive advantage of allowing their compression ratio to be increased in a controlled way when the charge introduced into their cylinder(s) is highly diluted, particularly if said engines operate with partial charges, while allowing said ratio to be reduced when the charge is higher and/or less diluted.

Accordingly, said variable compression engines allow the combustion of charges which are highly diluted with exhaust gases having low coefficients of cyclic variation, in other words small differences in combustion rate from one cycle to another and from one cylinder to another.

However, it should be noted that a high compression ratio is unfavorable to the conversion of the macroscopic movements of the charge into fine turbulence at the top dead center of the piston of said engine, said turbulence being favorable to the fast propagation of the flame in the fuel-air mixture.

In order to overcome this problem, a combustion chamber of what is known as the “squish” type can be provided, this chamber producing high turbulence when the piston reaches the vicinity of its top dead center.

However, the problem with squish chambers is that the piston has to be brought very close to the cylinder head, entailing a risk of collision between said piston and said cylinder head, while the desired squish effect is provided only in the vicinity of the top dead center, in other words relatively late with respect to the moment of the spark-initiated ignition of the charge.

Another drawback of squish chambers is that they strongly promote heat exchange between the gases and the internal walls of the combustion chamber.

In view of the above, it would clearly be advantageous to be able to provide fast combustion of stoichiometric charges highly diluted with external cooled EGR, in such a way that the polluting products could be post-treated with a three-way catalytic converter, without any excess turbulence which would counteract the reduction of the heat losses at the walls which is the desired effect of the dilution of said charge by said EGR. It would also be clearly advantageous to arrange for the combustion of the highly diluted stoichiometric charges over the widest possible operating range of the heat engine.

### SUMMARY OF THE INVENTION

It is in order to meet this objective, to overcome the various aforementioned problems encountered in the prior art regarding internal combustion engines, and to enable these engines to be used in an economical, clean and fuel-saving manner that the high-pressure spark-ignition and stratification device for a reciprocating internal combustion engine with a highly diluted charge proposes, according to the invention and according to a particular embodiment:
To create a pocket of stoichiometric fuel-air gas mixture forming what is called a “pilot” charge of small volume and mass, with a low content of EGR, which is centered, as far as possible, around the ignition point, is locally turbulent even in operation at a high compression ratio, is produced at the most suitable moment during the compression phase, and is then ignited by an electric arc struck between the electrodes of a spark plug.
   This has the purpose of:
Using the combustion of said pilot charge to provide, over a wide operating range of reciprocating internal combustion engines, ignition and combustion of a stoichiometric charge called the “main” charge, prepared in advance in the intake and/or compression phase and highly diluted with external cooled EGR supplied by an exhaust gas tapping device interacting with a cooler.
   This has the effect of:
Generating a locally high turbulence in the pilot charge surrounding the ignition point and at the interface between said pilot charge and the main charge, so as to promote the rapid development of a wide flame front in the three-dimensional space of the combustion chamber, while retaining a globally moderate turbulence within said main charge in order to limit the convective heat exchange between the hot gases of said main charge and the internal wall of said chamber;
   And has the following results:
Allowing the combustion of stoichiometric charges with a very high content of external cooled EGR;
Promoting fast, regular combustion of said stoichiometric charges close to the isochore;
Benefiting from the high energy efficiency of the stratified charge used in excess air, but by means of the stratification of stoichiometric charges which are highly diluted with external cooled EGR, so as to allow the post-treatment of pollutants produced by the combustion using a simple three-way catalytic converter and thus avoiding the use of costly, heavy and bulky NOx traps or selective catalytic reduction (SCR) devices;
Greatly extending the range of operating loads and positive effects on the efficiency of the stratification, from the lowest loads to relatively high or very high loads;
Significantly reducing the fuel consumption of all motor vehicles, including low powered vehicles and thermal-electric hybrid vehicles in which methods such as the reduction of cylinder capacity, known as “downsizing”, or the inactivation of cylinders have little or no positive effect on energy performance, said reduction in consumption being achieved, according to the invention, not by the repositioning of the engine operation in its speed-load ranges offering the best energy efficiency, but by increasing the energy efficiency over almost the whole operating range of said engine;
Making the high levels of downsizing of engines less necessary for reducing the mean consumption of motor vehicles, said high levels of downsizing significantly increasing the production cost of said vehicles, notably because of the high-performance supercharger systems which are required in these cases;
Allowing the production of engines having very low cylinder capacity with high energy efficiency, notably by reducing the unfavorable effect on their thermodynamic efficiency of the high surface/volume ratio of their combustion chambers which leads to high heat losses, this being achieved according to the invention by a significant reduction in the mean charge temperature of said engines due to the high dilution of said charge with external cooled EGR, said dilution naturally reducing said heat losses of said engines;
Enabling the engines to operate at a high compression ratio in order to increase the thermodynamic efficiency, this being made possible, on the one hand, by a high resistance to pinging of the principal charge because of its high degree of dilution with external cooled EGR, and, on the other hand, by a high resistance to pinging of the pilot charge because of its proximity to the ignition point and its consequent fast combustion;
Naturally reducing the pumping losses of the engines, since the large-scale introduction of external cooled EGR into their cylinder(s) has the effect of increasing the intake pressure of said engines and thus opening their butterfly valves wider for a given operating point, said natural reduction of the pumping losses making it less necessary to use complex and costly devices for variable lifting of the intake valves to reduce said losses;
Avoiding the delayed gasoline injection during the compression phase that is characteristic of the operation of stratified charge engines operating in excess air, thereby avoiding the large-scale production of fine particles during combustion and thus avoiding the use of a costly and bulky particle filter for the post-treatment of said fine particles;
Enabling the charge to be stratified with a multi-point gasoline injection system as an alternative to the direct gasoline injection normally used to stratify the charge, the latter form of injection being more complicated and costly;
Providing freedom from the internal geometric constraints of the combustion chamber and of the intake conduit(s) and/or freedom from the constraints on the positioning and shape of the injector jet imposed by the use of the stratified charge according to the prior art, said constraints arising from the need to provide a combustible pocket which is approximately centered around the ignition point and leading to various aerodynamic arrangements within the combustion chamber and within the intake conduit(s), mainly known under the terms “wall-guided”, “air-guided” and “spray-guided”, whereas these constraints are virtually dispensed with by using the ignition device according to the invention which offers greater freedom in the design of said chamber and said conduits;
Allowing the stratification of charges highly diluted with external cooled EGR in engines of low unitary cylinder capacity, in which, firstly, the small bore is poorly compatible or even incompatible with direct injection which requires a minimum distance between the source of the injection jet and the walls of the combustion chamber, and, secondly, the mean charge currently used is potentially too high for sufficient benefit to be obtained from the advantages of the stratified charge operating with excess oxygen where operation is too limited at low loads, or in which, thirdly, the overall production cost of said stratified charge and of the associated post-treatment devices is too high relative to the category of vehicles for which said engines are intended;
Providing a fast temperature rise in the engines, notably because of the cooling of the recirculated exhaust gases via an air/water heat exchanger heated by the cooling water of said engines, this fast temperature rise making it possible, notably, to reduce the viscosity of the lubricating oil of said engines and the associated frictional losses, this resulting in a lower fuel consumption of the motor vehicles when they are used on short journeys beginning with a cold start of said engines, said fast temperature rise also having the advantage of improving the passenger comfort of said vehicles because of the faster temperature rise of the passenger compartments of said vehicles in the winter period;
Greatly reducing the consumption of gasoline and the associated carbon dioxide emissions of all motor vehicles at a limited production cost.

It should be noted that the ignition device according to the invention can also be used in non-stoichiometric engines operating with excess oxygen.

It should also be noted that the ignition device according to the invention can be applied to any reciprocating internal combustion engine with a fixed or variable compression ratio and/or cylinder capacity, but that it offers more optimal operation when it is used in an engine having at least a variable compression ratio, since this type of engine makes it possible to benefit from a high level of downsizing, owing to excellent efficiency at very high loads and owing to a distinctive capacity to handle said very high loads even without external cooled EGR using a temporarily low compression ratio, and also to benefit from a very high rate of external cooled EGR at low and intermediate loads where combustion is made possible by a temporarily high compression ratio. Without excluding any other application, the ignition device according to the invention is particularly suitable for reciprocating internal combustion engines used to power motor vehicles.

The high-pressure spark-ignition and stratification device for an internal combustion engine according to the present invention comprises:
at least one stratification valve housed in the cylinder head of the internal combustion engine, said valve being kept in contact with a seat by at least one spring and said valve closing a first end of at least one stratification conduit which opens into a stratification prechamber while a second end that said conduit comprises opens into a stratification chamber, the latter being connected by at least one stratification injection conduit to the combustion chamber of the internal combustion engine, said injection conduit opening into said combustion chamber near protruding electrodes of a spark plug fixed in the cylinder head of the internal combustion engine, said electrodes being positioned in the combustion chamber of said engine;
at least one stratification actuator controlled by the ECU computer of the internal combustion engine, said actuator being responsible for lifting the stratification valve off its seat, keeping it open and returning it to its seat;
at least one stratification line connecting the stratification prechamber to the outlet of a stratification compressor the inlet of which is connected directly or indirectly to an atmospheric stratification air supply conduit, said supply conduit, said compressor and the inlet and outlet thereof, said line, said prechamber and the stratification conduit forming in combination an atmospheric air supply circuit for the stratification chamber, and said chamber itself forming an integral part of said circuit;
at least one stratification fuel injector controlled by the ECU computer of the internal combustion engine, said injector being capable of producing a jet of fuel either within the atmospheric air supply circuit for the stratification chamber at any point in said circuit, or within the stratification injection conduit, or within said circuit and said conduit;
at least means of recirculating previously cooled exhaust gases, called “external cooled EGR” means, controlled by the ECU computer of the internal combustion engine, said means making it possible to tap exhaust gases from the exhaust conduit of said engine and then reintroduce said gases to the intake side of said engine after said gases have previously been cooled by means of at least one cooler.

The high-pressure spark-ignition and stratification device according to the present invention comprises a seat of the stratification valve which has a face oriented toward the outside of the stratification prechamber in such a way that the stratification actuator can lift said valve of said seat only by moving said valve away from said prechamber.

The high-pressure spark-ignition and stratification device according to the present invention comprises a seat of the stratification valve which has a seat which is oriented toward the inside of the stratification prechamber so that the stratification actuator can lift said valve of said seat only by moving said valve closer toward said prechamber.

The high-pressure spark-ignition and stratification device according to the present invention comprises a stratification actuator which consists of at least one coil of conductive wire secured to the cylinder head of the internal combustion engine, said coil attracting a magnetic core or blade when an electric current flows through said coil, so that said one core or blade moves in longitudinal translation the stratification valve to which it is connected by coil pushing or pulling means.

The high-pressure spark-ignition and stratification device according to the present invention comprises a stratification actuator which consists of at least one stack of piezoelectric layers the thickness of which varies when said layers are subjected to the passage of an electric current, in such a way that said stack moves in longitudinal translation the stratification valve to which it is connected by stack pushing or pulling means.

The high-pressure spark-ignition and stratification device according to the present invention comprises a stack of piezoelectric layers which is connected to the stratification valve by means of at least one lever which multiplies the displacement imparted by said stack to said valve.

The high-pressure spark-ignition and stratification device according to the present invention comprises a stratification actuator which consists of a pneumatic stratification actuating cylinder comprising a pneumatic stratification receiving chamber and a pneumatic stratification receiving piston, said piston being secured to the stratification valve or being connected thereto by pneumatic piston pushing or pulling means, whereas said pneumatic chamber can be placed in communication either with a high-pressure reserve of air or the open air or with a low-pressure reserve of air by at least one solenoid valve.

The high-pressure spark-ignition and stratification device according to the present invention comprises a stratification actuator which consists of a hydraulic stratification actuating cylinder comprising a hydraulic stratification receiving chamber and a hydraulic stratification receiving piston, said piston being secured to the stratification valve or being connected to the latter by hydraulic piston pulling or pushing means.

The high-pressure spark-ignition and stratification device according to the present invention comprises a hydraulic stratification receiving chamber which may be connected either to a high-pressure hydraulic control fluid reservoir or to a low-pressure hydraulic control fluid reservoir by at least one high-pressure solenoid valve and/or by at least one low-pressure solenoid valve.

The high-pressure spark-ignition and stratification device according to the present invention comprises a high-pressure hydraulic control fluid reservoir which is pressurized by a hydraulic control pump, said pump transferring hydraulic fluid tapped from the low-pressure hydraulic control fluid reservoir so that it can be transferred to said high-pressure hydraulic control fluid reservoir.

The high-pressure spark-ignition and stratification device according to the present invention comprises a stratification fuel injector which is connected to a reservoir of pressurized combustible gas.

The high-pressure spark-ignition and stratification device according to the present invention comprises an atmospheric air supply circuit for the stratification chamber which comprises a homogenization circulator, said circulator being placed at any point of said circuit and aggregating atmospheric air or a gaseous mixture contained in said circuit by causing said air or said mixture to circulate through said circuit.

The high-pressure spark-ignition and stratification device according to the present invention comprises an atmospheric air supply circuit for the stratification chamber which comprises an air-to-air heat exchanger for heating the supply circuit which heats atmospheric air or gaseous mixture contained in said circuit by extracting heat from the exhaust gases of the internal combustion engine, said air or gaseous mixture and said exhaust gases passing simultaneously through said exchanger without mixing with one another.

The high-pressure spark-ignition and stratification device according to the present invention comprises an atmospheric air supply circuit for the stratification chamber which comprises at least one electrical resistance for heating the supply circuit which heats atmospheric air or gaseous mixture contained in said circuit.

The high-pressure spark-ignition and stratification device according to the present invention comprises an internal surface of the atmospheric air supply circuit of the stratification chamber which is wholly or partially covered with a thermal insulation material.

The high-pressure spark-ignition and stratification device according to the present invention comprises an atmospheric air supply circuit for the stratification chamber which comprises an air-to-cooling water heat exchanger for cooling the supply circuit which cools atmospheric air or gaseous mixture contained in said circuit by surrendering heat from said atmospheric air or gaseous mixture to a heat-transfer fluid contained in the cooling circuit of the internal combustion engine.

The high-pressure spark-ignition and stratification device according to the present invention comprises stratification chamber which comprises at least one inlet and/or at least one outlet which is/are tangential.

The high-pressure spark-ignition and stratification device according to the present invention comprises an atmospheric air supply circuit for the stratification chamber which comprises at least one agitation chamber which imparts a turbulent motion to a gaseous mixture which is moving in said circuit or which causes the gaseous mixture to undergo rapid pressure variations.

The high-pressure spark and stratification ignition device according to the present invention comprises a stratification line which comprises at least one discharge valve which opens over a particular pressure prevailing in said line.

The high-pressure spark-ignition and stratification device according to the present invention comprises a stratification line and/or an outlet of the stratification compressor and/or a stratification prechamber which comprises at least one discharge solenoid valve the outlet of which opens into the intake side of the internal combustion engine, or into a canister, or into a storage reservoir.

The high-pressure spark-ignition and stratification device according to the present invention comprises an outlet of the stratification compressor which is connected to a pressure accumulator which stores atmospheric air or a gaseous mixture previously pressurized by said compressor, said accumulator also communicating directly or indirectly with the stratification line and the stratification prechamber so as to keep said line and said prechamber under pressure.

The high-pressure spark-ignition and stratification device according to the present invention comprises means for recirculating previously cooled exhaust gases, called “external cooled EGR” means, which consist of at least one proportional-lift EGR tapping valve or of at least one proportional-rotation EGR tapping flap valve or of at least one proportional-rotation EGR tapping sleeve valve positioned on the exhaust manifold of the internal combustion engine, said valve or said flap valve or said sleeve valve being capable of placing said manifold in communication with an external EGR supply conduit of which the opposite end to the end that opens into said manifold opens into the intake plenum of the internal combustion engine.

The high-pressure spark-ignition and stratification device according to the present invention comprises a proportional-lift EGR tapping valve or a proportional-rotation EGR tapping flap valve or a proportional-rotation EGR tapping sleeve valve positioned on the exhaust manifold which collaborates with at least one proportional-lift exhaust back-pressure valve or with a proportional-rotation exhaust back-pressure flap valve or with a proportional-rotation exhaust back-pressure sleeve valve that at least one of the outlets of said manifold comprises.

The high-pressure spark-ignition and stratification device according to the present invention comprises a stratification EGR cooler which is a high-temperature air-to-water exchanger in the external EGR supply conduit which cools the exhaust gases tapped from the exhaust conduit of the internal combustion engine, said exhaust gases surrendering some of their heat to a heat-transfer fluid contained in the cooling circuit of said internal combustion engine.

The high-pressure spark-ignition and stratification device according to the present invention comprises a stratification EGR cooler which is a low-temperature air-to-water exchanger in the external EGR supply conduit which cools the exhaust gases tapped from the exhaust conduit of the internal combustion engine, said exhaust gases surrendering some of their heat to a heat-transfer fluid contained in an independent cold water circuit that said internal combustion engine comprises.

The high-pressure spark-ignition and stratification device according to the present invention comprises a stratification chamber which consists of an annular cavity formed in a cylindrical hole in which a cylindrical sealing tip that the spark plug comprises is engaged, said hole opening into the combustion chamber of the internal combustion engine.

The high-pressure spark-ignition and stratification device according to the present invention comprises a stratification injection conduit which consists of at least one stratification injection channel a first end of which communicates with the stratification chamber and a second end of which opens between the inside of the cylindrical sealing tip and a central insulating cone that the spark plug comprises.

The high-pressure spark-ignition and stratification device according to the present invention comprises a stratification injection conduit which consists of at least one stratification injection capillary formed inside a central electrode that the spark plug comprises so that the first end of said capillary communicates with the stratification chamber and the second end of said capillary opens at the end of said central electrode.

The high-pressure spark-ignition and stratification device according to the present invention comprises a stratification injection conduit which consists of at least one peripheral stratification nozzle a first end of which communicates with the stratification chamber and a second end of which opens at the periphery of the spark plug, said second end being directed approximately toward the electrodes that said spark plug comprises.

The high-pressure spark-ignition and stratification device according to the present invention comprises at least the stratification valve, the seat, the spring, or all part of the stratification conduit, the stratification prechamber and the stratification actuator which are incorporated in combination into at least one cartridge fixed or screwed into the cylinder head of the internal combustion engine.

The high-pressure spark-ignition and stratification device according to the present invention comprises a stratification line and/or an outlet of the stratification compressor and/or a stratification prechamber which comprises at least one valve or injector of air-fuel mixture making it possible to keep the pollutant post-treatment catalytic converter at temperature, said type of valve or injector being capable of transferring an air-fuel mixture from said line or from said outlet or from said prechamber to the exhaust conduit of the internal combustion engine, said mixture being introduced into said conduit by said type of valve or injector at any point of said conduit positioned between the exhaust valve of said engine and said catalytic converter of said engine.

The high-pressure spark-ignition and stratification device according to the present invention comprises a valve or injector for an air-fuel mixture for keeping the catalytic converter at temperature which is connected to the exhaust conduit of the internal combustion engine by a catalytic converter temperature maintaining air-fuel mixture conduit.

### BRIEF DESCRIPTION OF THE DRAWINGS

The following description which refers to the appended drawings, provided by way of non-limiting examples, will assist in the understanding of the invention, its features and the advantages it can provide:

FIG. 1 is a schematic view of the high-pressure spark-ignition and stratification device according to the invention mounted on a reciprocating internal combustion engine.

FIGS. 2 and 3 are schematic sectional views of the high-pressure spark-ignition and stratification device according to the invention, with the stratification valve respectively in the closed and then open position, it being possible for said valve to be lifted off its seat by a stratification actuator consisting of a coil of conductive wire capable of attracting a magnetic core connected to said valve by coil pushing or pulling means.

FIG. 4 is a schematic sectional view of the high-pressure spark-ignition and stratification device according to the invention in which the stratification valve can be lifted off its seat by a stratification actuator consisting of a stack of piezoelectric layers which is connected to said valve by stack pushing or pulling means.

FIG. 5 is a schematic sectional view of the high-pressure spark-ignition and stratification device according to the invention the stratification valve of which can be lifted off its seat by a stratification actuator consisting of a hydraulic stratification actuating cylinder the hydraulic stratification receiving piston of which is connected to said valve by hydraulic piston pushing or pulling means.

FIG. 6 illustrates a first variant arrangement of the various components of the high-pressure spark-ignition and stratification device according to the invention, said device being applied to a reciprocating internal combustion engine with four in-line cylinders supercharged by a turbocharger, and said variant notably comprising a homogenization circulator, a proportional-lift EGR tapping valve and a proportional-lift exhaust back-pressure valve.

FIG. 7 illustrates a second variant arrangement of the various components of the high-pressure spark-ignition and stratification device according to the invention, said device being applied to a reciprocating internal combustion engine with four in-line cylinders supercharged by a turbocharger and said variant notably comprising a pressure accumulator which stores atmospheric air or the gaseous mixture pressurized by the stratification compressor, a stratification fuel injector connected to a reservoir of pressurized combustible gas, a proportional-lift EGR tapping flap valve and a proportional-lift exhaust back-pressure flap valve.

FIG. 8 shows a third variant arrangement of the various components of the high-pressure spark-ignition and stratification device according to the invention, said device being applied to a reciprocating internal combustion engine with four in-line cylinders supercharged by a turbocharger and said variant comprising notably an air-to-air heat exchanger for heating the atmospheric air supply circuit, a proportional-lift EGR tapping sleeve valve and a proportional-lift exhaust back-pressure sleeve valve.

### DETAILED DESCRIPTION OF THE INVENTION

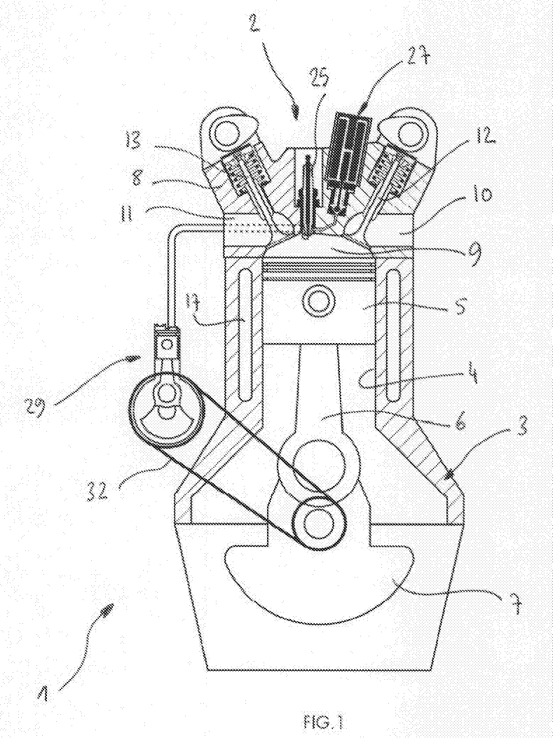

FIG. 1 shows an internal combustion engine 1 comprising a high-pressure spark-ignition and stratification device 2 according to the present invention.

The internal combustion engine 1 comprises an engine block or crankcase 3 which contains at least one combustion cylinder 4 closed by a cylinder head 8 and in which a combustion piston 5 moves.

The combustion piston 5 is mounted articulated on a connecting rod 6 connected to a crankshaft 7, said connecting rod 6 transmitting the movement of said combustion piston 5 to said crankshaft 7 when said piston 5 moves inside the combustion cylinder 4.

The cylinder head 8 of the internal combustion engine 1 comprises a combustion chamber 9 into which there open, on the one hand, an intake conduit 11 which may or may not be closed off by an intake valve 13 and which communicates with an intake plenum 19 and, on the other hand, an exhaust conduit 10 which may or may not be closed off by an exhaust valve 12 and which communicates with an exhaust manifold 18 and with a catalytic converter 75 for the post-treatment of the pollutants.

The internal combustion engine 1 further comprises a cooling circuit 17 and a computer ECU.

FIGS. 1 to 8 show the high-pressure spark ignition and stratification device 2 according to the present invention.

The high-pressure spark-ignition and stratification device 2 comprises at least one stratification valve 20 housed in the cylinder head 8 of the internal combustion engine.

Said valve is kept in contact with a seat 21 by at least one spring 22, said valve closing a first end of at least one stratification conduit 23 which opens into a stratification prechamber 79, whereas a second end that said conduit comprises opens into a stratification chamber 24.

The stratification chamber 24 is connected by at least one stratification injection conduit 39 to the combustion chamber 9 of the internal combustion engine 1, said injection conduit 39 opening into said combustion chamber 9 near protruding electrodes 26 of a spark plug 25 fixed into the cylinder head 8 of the internal combustion engine 1, said electrodes being positioned in the combustion chamber 9 of said engine 1.

According to one particular embodiment of the high-pressure spark-ignition and stratification device 2 according to the invention, said spark plug 25 may be identical to or similar to those fitted to controlled-ignition internal combustion engines such as known to those skilled in the art.

It will be noted that the spring 22 may act directly or indirectly by means of a solid or of a fluid on the stratification valve 20, whereas it may be mechanical whatever the material, may operate in flexion, torsion or traction, and may be, for example, a “Belleville” spring washer, a helical or leaf spring, a corrugated spring washer or a spring washer having any other geometry and may be of any type known to those skilled in the art.

In a particular embodiment, said spring 22 may also be pneumatic, using the properties of compressibility of a gas, or hydraulic, using the properties of compressibility of a fluid.

It will be noted that the high-pressure spark-ignition and stratification device 2 comprises at least one stratification actuator 27 controlled by the computer ECU of the internal combustion engine 1, said actuator being responsible for lifting the stratification valve 20 of its seat 21, keeping it open and returning it to its seat.

The high-pressure spark-ignition and stratification device 2 also comprises at least one stratification line 28 connecting the stratification prechamber 79 to the outlet of a stratification compressor 29 the inlet of which is connected directly or indirectly to a stratification atmospheric air supply conduit 30.

Said supply conduit, said compressor and the inlet and outlet thereof, said line, said prechamber and the stratification conduit 23 in combination form an atmospheric air supply circuit 31 for the stratification chamber 24, and said chamber itself forms an integral part of said circuit.

It will be noted that the stratification compressor 29 may be of any type known to those skilled in the art, said compressor be of fixed or variable cylinder capacity, have piston(s), vanes, screws with or without lubrication, may be single-stage, two-stage or multi-stage and may or may not have intermediate cooling.

Depending on the chosen way of embodying the high-pressure spark-ignition and stratification device 2 according to the invention, said stratification compressor 29 may notably be fixed directly or indirectly to the internal combustion engine 1 and be mechanically driven by the crankshaft 7 that said engine comprises via at least one pinion or via at least one chain or via at least one belt 32 via a transmission having fixed or variable transmission ratio, or electrically via an alternator driven by said crankshaft which produces the current required by an electric motor driving said compressor, in which case the electrical energy produced by said alternator may or may not be stored in advance in a battery.

The high-pressure spark-ignition and stratification device 2 further comprises at least one stratification fuel injector 33 controlled by the ECU computer of the internal combustion engine 1, it being possible for said injector to produce a jet of fuel either within the atmospheric air supply circuit 31 for the stratification chamber 24 at any point in said circuit or within the stratification injection conduit 39, or within said circuit and said conduit.

According to one particular embodiment of the device according to the invention, said stratification fuel injector 33 may inject a liquid or gaseous fuel and may be a single-stage or multiple-stage injector of the solenoid or piezoelectric type or, in general, of any type known to those skilled in the art.

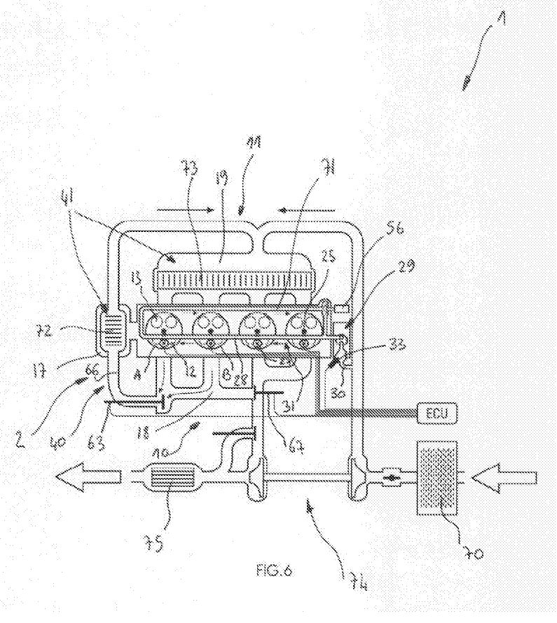

As has been shown in FIGS. 6, 7 and 8, the high-pressure spark-ignition and stratification device 2 comprises at least means for recirculating previously cooled exhaust gases 40, called “external cooled EGR” means, controlled by the ECU computer, these previously cooled exhaust gas recirculation means 40 making it possible to tap exhaust gases from the exhaust conduit 10 of the internal combustion engine 1 and then reintroduce said gases into the intake side of said engine after said gases have been cooled by means of at least one cooler 41.

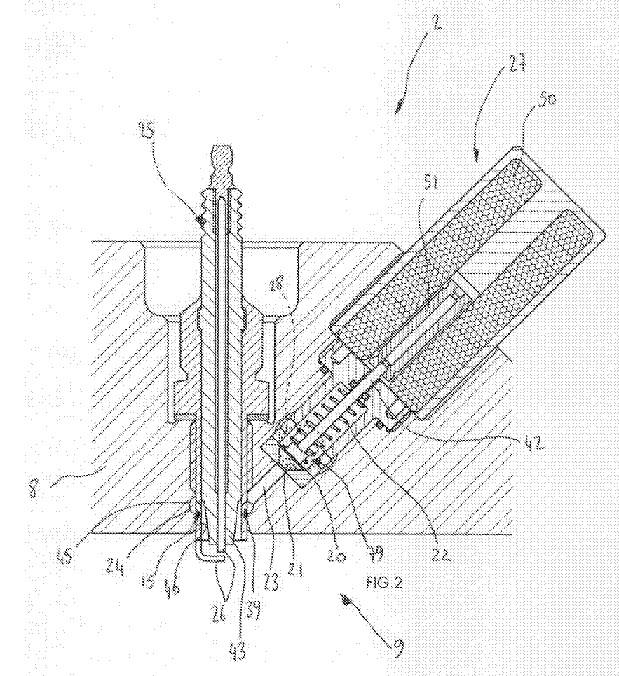

In a certain embodiment, the high-pressure spark-ignition and stratification device 2 comprises a stratification valve 20 the seat 21 of which has a face which is oriented toward the outside of the stratification prechamber 79 so that the stratification actuator 27 can lift said valve of said seat only by moving said valve away from said prechamber (FIGS. 2 to 5).

According to another embodiment, the high-pressure spark-ignition and stratification device 2 comprises a stratification valve 20 the seat 21 of which has a face which is oriented towards the inside of the stratification prechamber 79 so that the stratification actuator 27 can lift said valve of said seat only by moving said valve toward said prechamber.

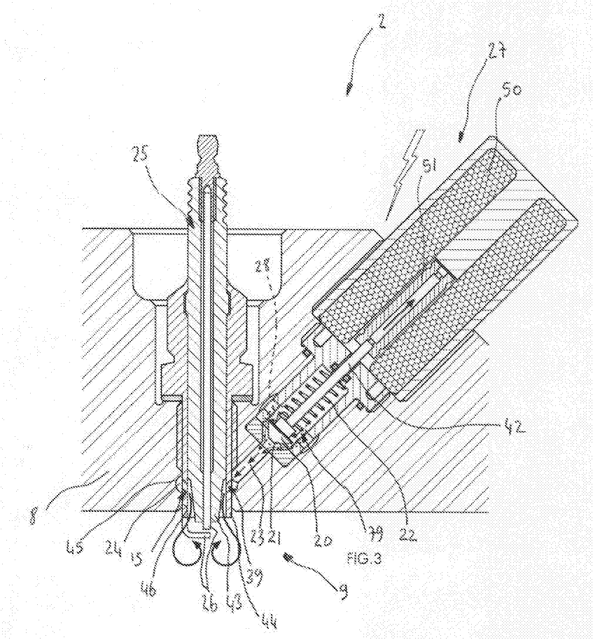

As has been shown in FIGS. 2 and 3, the stratification actuator 27 may consist of at least one coil of conductive wire 50 secured to the cylinder head 8 of the internal combustion engine 1, said coil attracting a magnetic core or blade 51 when an electric current flows through said coil, so that said one core or blade moves in longitudinal translation the stratification valve 20 to which it is connected by coil pushing or pulling means 42.

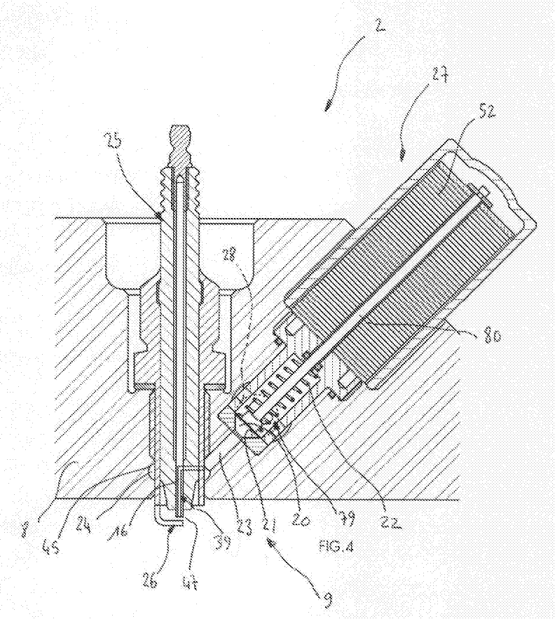

FIG. 4 shows that the stratification actuator 27 may consist of at least one stack of piezoelectric layers 52 the thickness of which varies when said layers are subjected to a flow of electric current, so that said stack moves in longitudinal translation the stratification valve 20 to which it is connected by stack pushing or pulling means 80.

According to a variant of the device according to the invention, the stack of piezoelectric layers 52 may be connected to the stratification valve 20 via at least one lever (not depicted) which multiplies the displacement imparted by said stack to said valve.

Said lever may for example consist of a washer itself made up of a succession of small levers joined together in a circle, each small lever resting against the top of the stack of piezoelectric layers 52 on the one hand, and against the stratification valve 20 on the other, either directly or via stack pushing or pulling means 80.

According to another embodiment, the high-pressure spark-ignition and stratification device 2, the stratification actuator 27 may consist of a stratification pneumatic actuating cylinder (not depicted) comprising a stratification pneumatic receiving chamber and a stratification pneumatic receiving piston, said piston being secured to the stratification valve 20 or connected thereto by pneumatic piston pushing or pulling means, whereas said pneumatic chamber can be placed in communication either with a reserve of high-pressure air or with the open air or with a reserve of low-pressure air by at least one solenoid valve.

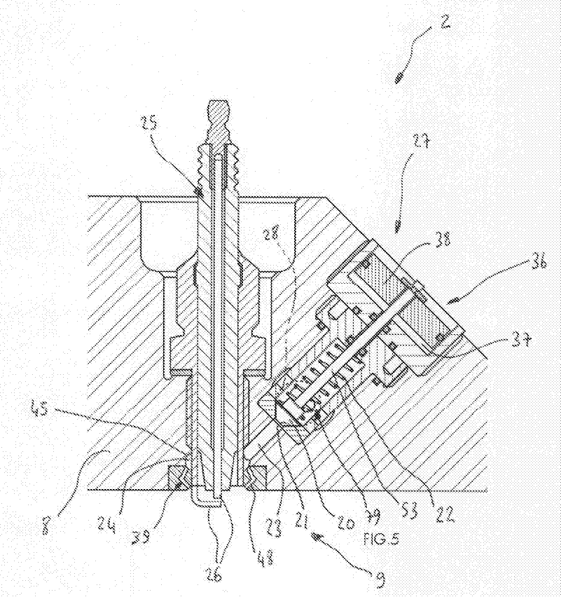

According to another variant depicted in FIG. 5, the high-pressure spark-ignition and stratification device 2 may comprise a stratification actuator 27 consisting of a stratification hydraulic actuating cylinder 36 and comprising a stratification hydraulic receiving chamber 37 and a stratification hydraulic receiving piston 38, said piston being secured to the stratification valve 20 or connected thereto by hydraulic piston pushing or pulling means 53.

Said hydraulic stratification receiving piston 38 may comprise seals to seal against a cylinder with which it interacts, and the hydraulic stratification receiving chamber 37 may be connected either to a high-pressure hydraulic control fluid reservoir or to a low-pressure hydraulic control fluid reservoir by at least one high-pressure solenoid valve and/or by at least one low-pressure solenoid valve.

The high-pressure spark-ignition and stratification device 2 may comprise a high-pressure hydraulic control fluid reservoir, not depicted, which is pressurized by a hydraulic control pump, said pump transferring a hydraulic fluid tapped from the low-pressure hydraulic control fluid reservoir to the high-pressure hydraulic control fluid reservoir.

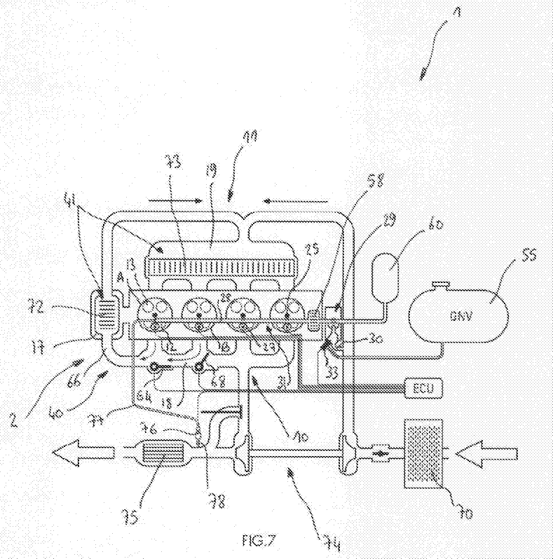

According to one particular embodiment, the high-pressure spark-ignition and stratification device 2 comprises a stratification fuel injector 33 which may be connected to a reservoir of pressurized combustible gas 55 (FIG. 7), it being possible for said gas to be injected by said injector 33 and for said gas for example to be compressed natural gas, or any other combustible gas that can be used by reciprocating internal combustion engines.

The atmospheric air supply circuit 31 for the stratification chamber 24 may comprises a homogenization circulator 56 placed at any point of said circuit and which agitates atmospheric air or a gaseous mixture contained in said circuit by causing said air or said mixture to circulate through said circuit.

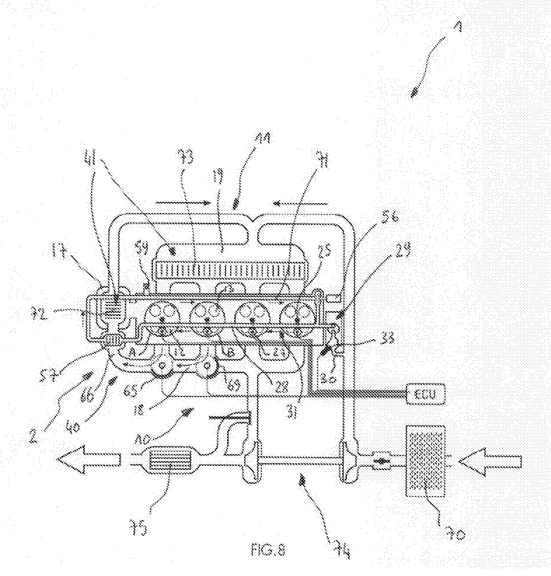

FIGS. 6 and 8 show an atmospheric air supply circuit 31 for the stratification chamber 24 which comprises an air-to-air heat exchanger 57 for heating said circuit 31 which heats atmospheric air or a gaseous mixture contained in said circuit 31 by extracting heat from the exhaust gases of the internal combustion engine 1, said air or gaseous mixture and said exhaust gases passing simultaneously through said exchanger 57 without mixing with one another.

According to one particular embodiment of the high-pressure spark-ignition and stratification device 2, the atmospheric air supply circuit 31 for the stratification chamber 24 comprises at least one electrical resistance for heating the supply circuit which heats atmospheric air or a gaseous mixture contained in said circuit (not depicted).

It will be noted that, possibly, the internal surface of the atmospheric air supply circuit 31 of the stratification chamber 24 may wholly or partially be covered with a thermal insulation material, which may be ceramic, air, or any other thermal insulation means known to those skilled in the art.

Said internal surface may also be covered with a non-stick material such as Teflon for example, or any other coating known to those skilled in the art and that makes it possible to avoid any products derived from the polymerization of the fuel circulating in said supply circuit 31 from adhering to said surface.

FIG. 7 shows the atmospheric air supply circuit 31 for the stratification chamber 24 which comprises an air-to-cooling water heat exchanger for cooling the supply circuit 58 which cools atmospheric air or a gaseous mixture contained in said circuit by surrendering heat from said atmospheric air or gaseous mixture to a heat-transfer fluid contained in the cooling circuit 17 of the internal combustion engine 1.

According to one embodiment, not depicted, the stratification chamber 24 comprises at least one inlet and/or at least one outlet which is/are tangential, so that said inlet and/or outlet are able to impart a swirling movement to the atmospheric air or to the gaseous mixture coming from the stratification line 28 when said air or mixture is introduced into said chamber.

The atmospheric air supply circuit 31 for the stratification chamber 24 may also comprise at least one agitation chamber, not depicted, which imparts a turbulent motion to a gaseous mixture which is moving in said circuit or which causes said gaseous mixture to undergo rapid pressure variations, said agitation chamber being able for example to create a venturi effect so as to encourage the evaporation of the fuel contained in said mixture on the one hand, and the aggregation of said mixture on the other hand.

According to one particular embodiment, the high-pressure spark-ignition and stratification device 2 comprises a stratification line 28 which may comprise at least one discharge valve 59 which opens over a particular pressure prevailing in said line, it being possible for the outlet from said discharge valve 59 to open—according to one particular embodiment of the device according to the invention—into the intake plenum 19 or into the exhaust circuit 10 of the internal combustion engine 1, or to the open air (FIG. 8).

The stratification line 28 and/or the outlet of the stratification compressor 29 and/or the stratification prechamber 79 may also comprise at least one discharge solenoid valve the outlet of which opens into the intake side of the internal combustion engine, or into a canister not depicted, or into a storage reservoir likewise not depicted.

It may be noted that said solenoid valve may be actuated so as to open when the internal combustion engine 1 stops, in such a way that said canister or said reservoir stores most of the hydrocarbon vapors contained in said stratification line 28 and/or said outlet of the stratification compressor 29 and/or said stratification prechamber 79, said vapors then being burnt when said engine is subsequently restarted, or in such a way that said vapors are burnt immediately by said engine when they are expelled to the intake side of said engine by said solenoid valve.

FIG. 7 shows that the outlet of the stratification compressor 29 may be connected to a pressure accumulator 60 which stores atmospheric air or a gaseous mixture previously pressurized by said compressor, said accumulator also communicating directly or indirectly with the stratification line 28 and the stratification prechamber 79 so as to keep said line and said prechamber under pressure.

Said pressure accumulator 60 serves notably to stabilize the pressure established in these members in the case in which, for example, the stratification compressor 29 includes a single piston rotating at low speed, this configuration generating high-amplitude pressure waves within said members.

The high-pressure spark-ignition and stratification device 2 comprises means 40 for recirculating previously cooled exhaust gases, called “external cooled EGR” means, which consist of at least one proportional-lift EGR tapping valve 63 (FIG. 6) or of at least one proportional-rotation EGR tapping flap valve 64 (FIG. 7) or of at least one proportional-rotation EGR tapping sleeve valve 65 (FIG. 8) positioned on the exhaust manifold 18 of the internal combustion engine 1, said valve or said flap valve or said sleeve valve being capable of placing said manifold in communication with an external EGR supply conduit 66 of which the opposite end to the end that opens into said manifold opens into the intake plenum 19 of the internal combustion engine.

The proportional-lift EGR tapping valve 63 or the proportional-rotation EGR tapping flap valve 64 or the proportional-rotation EGR tapping sleeve valve 65 positioned on the exhaust manifold 18 collaborates with at least one proportional-lift exhaust back-pressure valve 67 (FIG. 6) or with a proportional-rotation exhaust back-pressure flap valve 68 (FIG. 7) or with a proportional-rotation exhaust back-pressure sleeve valve 69 (FIG. 8) that at least one of the outlets of said manifold comprises.

FIGS. 6 to 8 show a stratification EGR cooler 41 which is a high-temperature air-to-water exchanger in the external EGR supply conduit which cools the exhaust gases tapped from the exhaust conduit 10 of the internal combustion engine 1, said exhaust gases surrendering some of their heat to a heat-transfer fluid contained in the cooling circuit 17 of said internal combustion engine.

FIGS. 6 to 8 also show a stratification EGR cooler 41 which is a low-temperature air-to-water exchanger in the external EGR supply conduit which cools the exhaust gases tapped from the exhaust conduit 10 of the internal combustion engine 1, said exhaust gases surrendering some of their heat to a heat-transfer fluid contained in an independent cold water circuit that said internal combustion engine comprises. It will be noted that said cold water circuit may be that of the charge air cooler that said engine comprises, such a circuit being known to those skilled in the art.

FIGS. 3 to 5 illustrate that the stratification chamber 24 consists of an annular cavity 45 formed in a cylindrical hole 46 in which a cylindrical sealing tip 44 that the spark plug 25 comprises is engaged, said hole 46 opening into the combustion chamber 9 of the internal combustion engine 1.

As depicted in FIGS. 2 and 3, the stratification injection conduit 39 may consist of at least one stratification injection canal 15 a first end of which communicates with the stratification chamber 24 and a second end of which opens between the inside of the cylindrical sealing tip 44 and a central insulating cone 43 that the spark plug 25 comprises.

However, FIG. 4 shows that the stratification injection conduit 39 consists of at least one stratification injection capillary 16 formed inside a central electrode 47 that the spark plug 25 comprises so that the first end of said capillary communicates with the stratification chamber 24 and the second end of said capillary opens at the end of said central electrode 47.

FIG. 5 illustrates that the high-pressure spark-ignition and stratification device 2 comprises a stratification injection conduit 39 which consists of at least one peripheral stratification nozzle 48 a first end of which communicates with the stratification chamber 24 and a second end of which opens at the periphery of the spark plug 25, said second end being directed approximately toward the electrodes 26 that said spark plug comprises.

It should be noted that at least the stratification valve, the seat 21, the spring 22, all or part of the stratification conduit 23, the stratification prechamber 79 and the stratification actuator 27 may be incorporated in combination into at least one cartridge fixed or screwed into the cylinder head 8 of the internal combustion engine 1.

FIG. 8 shows that the stratification line 28 and/or the outlet of the stratification compressor 29 and/or the stratification prechamber 79 may comprise at least one valve or injector 76 of air-fuel mixture making it possible to keep the pollutant post-treatment catalytic converter 75 at temperature.

Said valve or injector 76 may transfer an air-fuel mixture from said line 28 or from said outlet or from said prechamber 79 to the exhaust conduit 10 of the internal combustion engine 1, said mixture being introduced into said conduit 10 by said type of valve or injector 76 at any point of said conduit positioned between the exhaust valve 12 of said engine and said catalytic converter 75 of said engine 1.

Said mixture may thus and if necessary be introduced into said exhaust conduit 10 once said catalytic converter 75 for post-treating the pollutants has reached an operating temperature at which it can operate with at least adequate efficiency, in order to ensure that said mixture is burnt in said catalytic converter 75 in such a way that the latter is kept at a sufficient temperature to enable it to maintain a high pollutant to non-pollutant gas conversion efficiency.

In this case, the valve or injector 76 for introducing an air-fuel mixture for keeping the catalytic converter 75 at temperature may be connected to the exhaust conduit 10 of the internal combustion engine 1 by a catalytic converter temperature maintaining air-fuel mixture conduit 77, it also being possible for said mixing conduit 77 to comprise an insulating tube or flange 78 which prevents said conduit 77 from reaching an excessively high temperature.

### OPERATION OF THE INVENTION

The ignition device according to the invention operates in at least the following modes:
Combustion of a stoichiometric pilot charge only, the main charge not containing, in practice, either oxygen or fuel, but solely external cooled EGR and/or internal hot EGR.
Combustion of a stoichiometric pilot charge which then ignites a stoichiometric main charge which is highly diluted with external cooled EGR and/or internal hot EGR.
Combustion of a stoichiometric pilot charge which then ignites a stoichiometric main charge which is undiluted or only slightly diluted with external cooled EGR and/or internal hot EGR.
Combustion of a stoichiometric pilot charge only which is highly diluted, undiluted or only slightly diluted with external cooled EGR and/or internal hot EGR.

In a particular embodiment and use, the ignition device according to the invention operates as follows, for example when used in a four-cylinder reciprocating internal combustion heat engine as shown in FIGS. 6 to 8:

Phase of pressurization of the stratification line 28: the engine 1 is started in the same way as a prior art engine with multipoint injection, the ignition device 2 according to the invention not being used at this stage, except as regards the spark plug 25 included in the device.

Being directly driven by the crankshaft 7 of the engine according to this example, the stratification compressor 29 is put into operation at the same time as said crankshaft and draws in its own air tapped from the outlet of the air filter housing 70 of said engine.

In this particular embodiment, an injector 33 sprays fuel into the intake of said stratification compressor 29 in such proportions that a stoichiometric fuel-air mixture is delivered at the outlet of said compressor, directly into the stratification line 28.

In parallel with the action of the stratification compressor 29, the homogenization circulator 56 causes the stoichiometric fuel-air mixture to flow subsequently through the stratification line 28, through the various stratification prechambers 79 incorporated in each combustion cylinder 4 of the internal combustion engine 1 as specified by the invention, and then through the homogenization return conduit 71 so as to return to said circulator and start out again on the same circuit as long as said line 28 is pressurized and the internal combustion engine remains in operation.

The agitation created by the homogenization circulator 56 serves to reduce the condensation of the gasoline contained in the stoichiometric fuel-air mixture on the internal walls of the stratification line 28 and of the stratification chambers 24, said mixture being under pressure and therefore unfavorable to the maintenance of the vapor state of the gasoline.

This agitation also serves to force the stoichiometric fuel-air mixture to remain homogeneous and at a temperature close to that of said walls, said temperature being below the spontaneous ignition point of said mixture, and to clean said walls, notably by rediluting any gasoline residues adhering to said walls as a result of previous use of the ignition device according to the invention.

Under the action of the stratification compressor 29, the pressure of the stratification line 28 rises to a level greater than the pressure established in the combustion chamber 9 of the internal combustion engine 1 when the piston 5 of the latter reaches the end of its compression stroke, immediately before the ignition of the charge contained in said chamber. When said line has been pressurized, the ignition device according to the invention is ready to stratify the charge of said engine, which takes place as follows:

### Phase of Initial Stratification:

A few degrees of rotation of the crankshaft 7 of the engine before the initiation of the spark ignition of the main stoichiometric charge contained in the combustion chamber 9 of said engine by means of the spark plug 25, an electric current is sent to the terminals of the coil 50 of the electric stratification actuator 27 (FIG. 3).

The magnetic core 51 of said actuator is then attracted by said coil and moves toward the latter, pulling on the coil push or pull means 42 which connect it to the stratification valve 20, so as to lift said valve off its seat 21 and so that a fraction of the pressurized carburetted mixture contained in the stratification line 28 and, more specifically, in the stratification prechamber 79, escapes toward the combustion chamber 9 of the engine 1 via the stratification chamber 24 and the stratification injection conduit 39 respectively.

While escaping via the stratification injection conduit 39, said mixture enters at high speed the space between the cylindrical sealing tip 44 of the spark plug 25 and the central insulating cone 43 of said spark plug. In so doing, said mixture is agitated with a turbulent motion while remaining confined in a small volume centered around the electrodes 26 of the spark plug 25, said mixture thus constituting the stoichiometric pilot charge (FIG. 3).

Once the desired quantity of mixture has been transferred from the stratification line 28 to the combustion chamber 9 to form the pilot charge, the coil 50 of the stratification actuator 27 ceases to be supplied with electric current by the ECU of the internal combustion engine 1, the magnetic core 51 of said actuator returns to its initial position, pushed back by the spring 22 of the stratification valve 20 which at the same time is returned to its seat 21, i.e. the closed position.

The pilot charge is then ignited, a high-voltage current being applied to the terminals of the spark plug 25 so as to form an electric arc between the electrodes 26 of said spark plug. Since the pilot charge is stoichiometric and has a strong turbulent motion, it is ignited rapidly, and then forms a substantially spherical hot volume which expands rapidly under the effect of heat to form a substantially truncated spherical flame front with a large surface area in contact with the main charge, which is also rapidly ignited, because the distance which the flame still has to cover in order to burn the whole of said main charge is short. When this mode of combustion by pilot charge and main charge has been established, the previously cooled exhaust gas recirculation means 40, called “external cooled EGR” means, come into operation as follows:

Phase of Dilution of the Charge with External Cooled EGR:

In order to recirculate the exhaust gases, the previously cooled exhaust gas recirculation means 40 according to the invention and according to the present exemplary embodiment may include a proportional-lift EGR tapping valve 63 positioned on an exhaust manifold 18 which links the exhaust outlets of the cylinders A and B of the internal combustion engine 1 to one another and which is incorporated in said engine, said tapping valve 63 interacting with a proportional-lift exhaust back-pressure valve 67 positioned at the outlet of said manifold 18.

When the EGR tapping valve 63 is fully open and said exhaust back-pressure valve 67 is fully closed, all the exhaust gases from cylinders A and B are reintroduced into the intake plenum 19 of the internal combustion engine 1 via the tapping valve 63 and the external EGR supply conduit 66, the latter including an external EGR air-to-water cooler of the hot air type 72, in other words a cooler in which the water is that used to cool said engine itself, into which said gases flow to undergo a first temperature reduction, after which they flow into an air-to-water cooler of the cold water type 73 contained in the intake plenum 19 to undergo a second temperature reduction, the latter cooler also serving to cool the supercharging air of said engine when the engine is supercharged by its turbocompressor 74 (FIG. 6).

With this configuration and this setting, the air admitted at the intake of the engine 1 contains approximately fifty percent EGR and is at a temperature only a few degrees higher than that of the ambient air.

It can easily be deduced from this arrangement that the engine can be made to operate at between zero and fifty percent of external cooled EGR by varying the respective lift of the EGR tapping valves 63 and the exhaust back-pressure valves 67 incorporated in the exhaust manifold 18 of the exhaust outlets of cylinders A and B, the appropriate level of EGR being set at all times by the engine operating computer ECU according to a criterion of better energy efficiency and stability limits on the combustion of said engine.

It should be noted that, when the turbocompressor 74 of the engine 1 is used to supercharge the latter, the EGR tapping valve 63 and the exhaust back-pressure valve 67 are set in such a way that enough energy remains in the exhaust gases to allow the turbocompressor turbine to drive the centrifugal compressor incorporated in said turbocompressor in the desired conditions.

This requirement to reduce the EGR level in order to prioritize the energy available for said turbine has a smaller negative effect on the final efficiency of the engine when the engine has a variable compression ratio because in such instances said engine requires little or no external cooled EGR at full load in order to overcome pinging and/or to deliver high energy efficiency.

It should be noted that, when the engine 1 operates with high levels of external cooled EGR, combustion which is normally difficult or even impossible to initiate in the absence of the ignition device 2 according to the invention is made possible by said device in good conditions.

This is because the initiation of combustion of the stoichiometric main charge which is highly diluted with external cooled EGR is provided by the flame front with a large surface area developed on the periphery of the pilot charge and brought into contact with said main charge.

In this context, said main charge burns rapidly as a result, firstly, of the compression created by the combustion of the pilot charge, said compression increasing the enthalpy of said main charge which is as yet unburnt; secondly, of the large contact surface exposed to the flame; and thirdly, of the small distance still to be covered by said flame in order to burn all of said charge.

Since it is highly diluted with external cooled EGR, the mean temperature of the charge during combustion is lowered considerably, simultaneously reducing the sensitivity of the engine to pinging and the heat losses at the walls. It is then possible to initiate the combustion of the charge at the optimal moment according to a criterion of maximum efficiency, and to increase the compression ratio of the engine, which may be fixed or variable, in order to increase the thermodynamic efficiency of the gas expansion.

It should be noted that, in the case of an engine with a variable compression ratio, the mean external cold EGR content of the charge may advantageously be increased in parallel with the compression ratio, the increase of this being simultaneously favorable to the stability of combustion with a high level of external cooled EGR and to the thermodynamic efficiency of the gas expansion.

It should be noted that, on completion of the phase of pressurizing the stratification line 28, the phases of stratification and subsequent dilution of the charge with external cooled EGR may be delayed in time so as to allow the fuel stored in said line at the time of the last use of the internal combustion engine 1 to return to the vapor state as a result of the rise in temperature of the internal walls of said line and the agitation provided by the homogenization circulator 56.

This delay also enables all the energy contained in the exhaust gases of the engine to be reserved temporarily for the heating of the three-way catalytic converter of said engine before the charge of said engine is diluted with external cooled EGR.

It should be noted that the ignition device 2 according to the invention may enable combustion to be initiated in a single engine cycle in two different modes, the first mode being controlled spark ignition and used for the pilot charge, while the second mode is ignition initiated by compression according to the principles of CAI and HCCI and is used for the main charge.

According to this method of using the ignition device 2 according to the invention, the external cooled EGR may be entirely or partially replaced by internal hot EGR, so that the conditions of temperature, pressure and composition required for the correct initiation of combustion by CAI or HCCI can be provided for the main charge.

It should be noted that said initiation of combustion in said two different modes in the same engine cycle is easier to control if it is used in a variable compression ratio engine.

In a particular mode of use of the ignition device 2 according to the invention, the internal combustion engine may advantageously have a device for controlling the opening and/or closing and/or lifting of its intake valves 13 and/or its exhaust valves 12, in addition to or instead of a variable compression ratio.

This particular embodiment may be used, notably, to advance the closing of the intake valve 13 during the intake stroke of the combustion piston 5 of said engine 1, in order to reduce its residual pumping losses at low loads.

The last-mentioned method may be used, for example, to provide a very high volumetric ratio for said engine 1, in which the very high rate of expansion of the gases is favorable to high thermodynamic efficiency.

It is to be understood that the above description is provided purely by way of example, and does not in any way limit the scope of the invention, from which there would be no departure if the details of embodiment which have been described were to be replaced by any other equivalents.

1. A high-pressure spark-ignition and stratification device for an internal combustion engine (1), said engine comprising a cylinder head (8) having at least one combustion chamber (9) into which there open an intake conduit (11) communicating with an intake plenum (19), and an exhaust conduit (10) communicating with an exhaust manifold (18) and a catalytic converter (75) for post-treatment of the pollutants, said engine further comprising a pressurized lubrication circuit (14), a cooling circuit (17) and an ECU computer, the device comprising:
at least one stratification valve (20) housed in the cylinder head (8) of the internal combustion engine (1), said at least one stratification valve being kept in contact with a seat (21) by at least one spring (22) and said at least one stratification valve closing a first end of at least one stratification conduit (23) which opens into a stratification prechamber (79) while a second end that said conduit comprises opens into a stratification chamber (24), the stratification chamber being connected by at least one stratification injection conduit (39) to the at least one combustion chamber (9) of the internal combustion engine (1), said at least one stratification injection conduit (39) opening into said at least one combustion chamber (9) near protruding electrodes (26) of a spark plug (25) fixed in the cylinder head (8) of the internal combustion engine (1), said electrodes being positioned in the at least one combustion chamber (9) of said engine (1);
at least one stratification actuator (27) controlled by the ECU computer of the internal combustion engine (1), said actuator being responsible for lifting the at least one stratification valve (20) off a seat (21), keeping the at least one stratification valve open and returning the at least one stratification valve to its seat;
at least one stratification line (28) connecting the stratification prechamber (79) to the outlet of a stratification compressor (29) the inlet of which is connected directly or indirectly to an atmospheric stratification air supply conduit (30), said supply conduit, said compressor and the inlet and outlet thereof, said line, said prechamber and the at least one stratification conduit (23) forming in combination an atmospheric air supply circuit (31) for the stratification chamber (24), and said chamber itself forming an integral part of said circuit;
at least one stratification fuel injector (33) controlled by the ECU computer of the internal combustion engine (1), said injector being capable of producing a jet of fuel either within the atmospheric air supply circuit (31) for the stratification chamber (24) at any point in said circuit, or within the at least one stratification injection conduit (39), or within said circuit and said conduit; and
the at least one stratification injection conduit (39) comprises at least one peripheral stratification nozzle (48) a first end of which communicates with the stratification chamber (24) and a second end of which opens at the periphery of the spark plug (25), said second end being directed approximately toward the electrodes (26) that said spark plug comprises.

2. The high-pressure spark-ignition and stratification device for internal combustion engine according to claim 1, further comprising at least means of recirculating previously cooled exhaust gases, called “external cooled EGR” means (40), controlled by the ECU computer of the internal combustion engine (1), said means making possible to tap exhaust gases from the exhaust conduit (10) of said engine and then reintroduce said gases to the intake side of said engine after said gases have previously been cooled by means of at least one cooler (41).

3. The high-pressure spark-ignition and stratification device for internal combustion engine according to claim 1, wherein the seat (21) of the at least one stratification valve (20) has a face oriented toward the outside of the stratification prechamber (79) in such a way that the stratification actuator (27) can lift said at least one stratification valve off said seat only by moving said at least one stratification valve away from or closer toward said prechamber.

4. The high-pressure spark-ignition and stratification device for internal combustion engine according to claim 1, wherein the stratification actuator (27) comprises of at least one coil of conductive wire (50) secured to the cylinder head (8) of the internal combustion engine (1), said at least one coil attracting a magnetic core or blade (51) when an electric current flows through said at least one coil, so that said at least one core or blade moves in longitudinal translation the at least one stratification valve (20) to which is connected by coil pushing or pulling means (42).

5. The high-pressure spark-ignition and stratification device for internal combustion engine according to claim 1, wherein the stratification actuator (27) comprises at least one stack of piezoelectric layers (52) the thickness of which varies when said layers are subjected to the passage of an electric current, in such a way that said stack moves in longitudinal translation the at least one stratification valve (20) to which is connected by stack pushing or pulling means (80) and/or by means of at least one lever which multiplies the displacement imparted by said stack to said valve.

6. The high-pressure spark-ignition and stratification device for internal combustion engine according to claim 1, wherein the stratification actuator (27) comprises a pneumatic stratification actuating cylinder comprising a pneumatic stratification receiving chamber and a pneumatic stratification receiving piston, said piston being secured to the at least one stratification valve (20) or being connected thereto by pneumatic piston pushing or pulling means, whereas said pneumatic chamber can be placed in communication either with a high-pressure reserve of air or the open air or with a low-pressure reserve of air by at least one solenoid valve.

7. The high-pressure spark-ignition and stratification device for an internal combustion engine according to claim 1, wherein the stratification actuator (27) comprises a hydraulic stratification actuating cylinder (36) comprising a hydraulic stratification receiving chamber (37) and a hydraulic stratification receiving piston (38), said piston being secured to the at least one stratification valve (20) or being connected to the latter by hydraulic piston pulling or pushing means (53).

8. The high-pressure spark-ignition and stratification device for internal combustion engine according to claim 1, wherein the stratification fuel injector (33) is connected to a reservoir (55) of pressurized combustible gas.

9. The high-pressure spark-ignition and stratification device for internal combustion engine according to claim 1, wherein the atmospheric air supply circuit (31) for the stratification chamber (24) comprises a homogenization circulator (56), said circulator being placed at any point of said circuit and agitating atmospheric air or a gaseous mixture contained in said circuit by causing said air or said mixture to circulate through said circuit.

10. The high-pressure spark-ignition and stratification device for internal combustion engine according to claim 1, wherein the atmospheric air supply circuit (31) for the stratification chamber (24) comprises an air-to-air heat exchanger (57) for heating the supply circuit (31) which heats atmospheric air or a gaseous mixture contained in said circuit by extracting heat from the exhaust gases of the internal combustion engine (1), said air or gaseous mixture and said exhaust gases passing simultaneously through said air-to-air heat exchanger (57) without mixing with one another.

11. The high-pressure spark-ignition and stratification device for internal combustion engine according to claim 1, wherein the atmospheric air supply circuit (31) for the stratification chamber (24) comprises at least one electrical resistance for heating the supply circuit which heats atmospheric air or a gaseous mixture contained in said circuit.

12. The high-pressure spark-ignition and stratification device for internal combustion engine according to claim 1, wherein the atmospheric air supply circuit (31) for the stratification chamber (24) comprises an air-to-cooling water heat exchanger for cooling the supply circuit (58) which cools atmospheric air or a gaseous mixture contained in said circuit by surrendering heat from said atmospheric air or gaseous mixture to a heat-transfer fluid contained in the cooling circuit (17) of the internal combustion engine (1).

13. The high-pressure spark-ignition and stratification device for internal combustion engine according to claim 1, wherein the stratification chamber (24) comprises at least one inlet and/or at least one outlet which is/are tangential.

14. The high-pressure spark-ignition and stratification device for internal combustion engine according to claim 1, wherein the atmospheric air supply circuit (31) for the stratification chamber (24) comprises at least one agitation chamber which imparts a turbulent motion to a gaseous mixture which is moving in said circuit or which causes said gaseous mixture to undergo rapid pressure variations.

15. The high-pressure spark-ignition and stratification device for internal combustion engine according to claim 1, wherein the at least one stratification line (28) comprises at least one discharge valve (59) which opens over a particular pressure prevailing in said line.

16. The high-pressure spark-ignition and stratification device for internal combustion engine according to claim 1, wherein the at least one stratification line (28) and/or the outlet of the stratification compressor (29) and/or the stratification prechamber (79) comprises at least one discharge solenoid valve the outlet of which opens into the intake side of the internal combustion engine, or into a canister, or into a storage reservoir.

17. The high-pressure spark-ignition and stratification device for internal combustion engine according to claim 1, wherein the outlet of the stratification compressor (29) is connected to a pressure accumulator (60) which stores atmospheric air or a gaseous mixture previously pressurized by said compressor, said accumulator also communicating directly or indirectly with the at least one stratification line (28) and the stratification prechamber (79) so as to keep said line and said prechamber under pressure.

18. The high-pressure spark-ignition and stratification device for internal combustion engine according to claim 2, wherein the means (40) for recirculating previously cooled exhaust gases, called “external cooled EGR” means, comprises of at least one proportional-lift EGR tapping valve (63) or of at least one proportional-rotation EGR tapping flap valve (64) or of at least one proportional-rotation EGR tapping sleeve valve (65) positioned on the exhaust manifold (18) of the internal combustion engine (1), said valve or said flap valve or said sleeve valve being capable of placing said manifold in communication with an external EGR supply conduit (66) of which the opposite end to the end that opens into said manifold opens into the intake plenum (19) of the internal combustion engine.

19. The high-pressure spark and stratification ignition device for internal combustion engine according to claim 1, wherein the stratification chamber (24) comprises an annular cavity (45) formed in a cylindrical hole (46) in which a cylindrical sealing tip (44) that the spark plug (25) comprises is engaged, said hole (46) opening into the at least one combustion chamber (9) of the internal combustion engine (1).

20. The high-pressure spark-ignition and stratification device for internal combustion engine according to claim 1, wherein at least the at least one stratification valve (20), the seat (21), the at least one spring (22), all or part of the stratification conduit (23), the stratification prechamber (79) and the stratification actuator (27) are incorporated in combination into at least one cartridge fixed or screwed into the cylinder head (8) of the internal combustion engine (1).
